(19) United States
(12) Patent Application Publication
(10) Pub. No.: US 2012/0326812 A1
(43) Pub. Date: Dec. 27, 2012

(54) HIGH-FREQUENCY TRANSMISSION LINE AND CIRCUIT SUBSTRATE

(75) Inventor: Risato Ohhira, Tokyo (JP)

(73) Assignee: NEC CORPORATION, Tokyo (JP)

(21) Appl. No.: 13/581,739

(22) PCT Filed: Mar. 4, 2011
(86) PCT No.: PCT/JP2011/055127

§ 371 Date: Aug. 29, 2012

(30) Foreign Application Priority Data
Mar. 5, 2010 (JP) 2010-049038

(51) Int. Cl. H01P 3/08

(52) U.S. Cl. 333/238

(57) ABSTRACT

In order that the total distance of a first high-frequency current path, which is defined in the periphery of slits (34a, 36a), satisfies a prescribed relationship, the slits (34a, 36a) are respectively formed in a first conductor pattern (34) and a second conductor pattern (36) that configure a coplanar line (30). Thus, the first high-frequency current that flows along the peripheries of the slits (34a, 36a) combines with a second high-frequency current that flows along a signal line conductor (32) without significantly affecting the second high-frequency current. Thus, radiated electromagnetic waves are efficiently collected, and radiation loss in a wiring substrate (10) is efficaciously alleviated.

### TECHNICAL FIELD

The present invention relates to a high-frequency transmission line and circuit substrate, and more specifically relates to a high-frequency transmission line for transmitting high-frequency signals, and a circuit substrate in which this high-frequency transmission line is formed.

### BACKGROUND ART

A coplanar line is well known as a high-frequency transmission line for transmitting high-frequency signals. In particular, on both surfaces of the substrate in which a signal line is formed, a coplanar line in which a conductor pattern is formed as a ground is such that the value of the characteristic impedance is uniquely changeable based on the width of the signal line. Consequently, it is possible to design the width of the signal line relatively freely. In addition, this type of coplanar line has relatively little scattering of the high-frequency signal and radiation loss compared to a micro-strip line.

However, when the frequency of the signal being transmitted becomes high-frequency to a certain degree, the wavelength of the signal becomes less than the signal line length, so the difference between the electric potential of a conductor pattern formed on the surface of one side of the substrate and the electric potential of a conductor pattern formed on the surface of the other side of the substrate becomes large. When this occurs, it becomes impossible to ignore the effects of insertion loss, reflection loss or radiation loss.

Hence, various art has been proposed for efficiently transmitting signals with high frequencies (for example, see Patent Literature 1).

### PRIOR ART LITERATURE

### Patent Literature

Patent Literature 1: Japanese Patent No. 3282870

### DISCLOSURE OF INVENTION

### Problems to be Solved by the Invention

With the coplanar line disclosed in Patent Literature 1, the conductor patterns formed on both surfaces of the substrate are connected by multiple via conductors. Through this, the electric potential of the conductor pattern formed on the surface of one side of the substrate and the electric potential of the conductor pattern formed on the surface of the other side of the substrate become equal, so that as a result, loss in the signal line is reduced. In addition, the multiple via conductors connecting the conductor patterns shield electromagnetic waves radiated from the signal line, contributing to a reduction in loss in the signal line.

However, when the frequency of the signal being transmitted becomes a high frequency to a certain degree, shielding by the via conductors is insufficient and it becomes difficult to adequately control radiation loss in the signal line.

One countermeasure for controlling radiation loss that can be considered is reducing the array spacing of the via conductors to reduce the percentage of electromagnetic waves leaking from between the via conductors. However, in order to reduce the array spacing of the via conductors, highly precise technology is necessary, creating concerns about deterioration of yields in manufacturing processes. In addition, there is a certain technological limit to narrowing array spacing.

In consideration of the foregoing, it is an object of the present invention to provide a high-frequency transmission line having a simple structure and capable of efficiently transmitting high-frequency signals.

### Means for Solving the Problems

In order to achieve the above object, the high-frequency transmission line according to a first aspect of the present invention comprises:

a signal line conductor formed on a surface of a dielectric; and

a conductor pattern formed on the dielectric so as to extend along the signal line conductor;

wherein a slit extending along the signal line conductor is formed in the conductor pattern.

The circuit substrate according to a second aspect of the present invention comprises:

a substrate;

the high-frequency transmission line according to the first aspect of the present invention formed on a surface on one side of this substrate; and

a conductor pattern formed on a surface of the other side of this substrate.

### Efficacy of the Invention

With the present invention, it is possible to provide a high-frequency transmission line having a simple structure and capable of efficiently transmitting high-frequency signals.

### BRIEF DESCRIPTION OF DRAWINGS

FIG. 1 is a planar diagram of a wiring substrate according to a first preferred embodiment of the present invention;

FIG. 2 is a cross-sectional view of the wiring substrate taken along line A-A;

FIG. 3 is a cross-sectional view of the wiring substrate taken along line B-B;

FIG. 4 is a drawing schematically showing the path of high-frequency electric current;

FIG. 5 is a planar diagram of a wiring substrate according to a (first) variation;

FIG. 6 is a planar diagram of a wiring substrate according to a (second) variation;

FIG. 7 is a planar diagram of a wiring substrate according to a (third) variation;

FIG. 8 is a planar diagram of a wiring substrate according to a (fourth) variation;

FIG. 9 is a planar diagram of a wiring substrate according to a (fifth) variation; and

FIG. 10 is a drawing showing the relationship between radiation loss and frequency.

### MODE FOR CARRYING OUT THE INVENTION

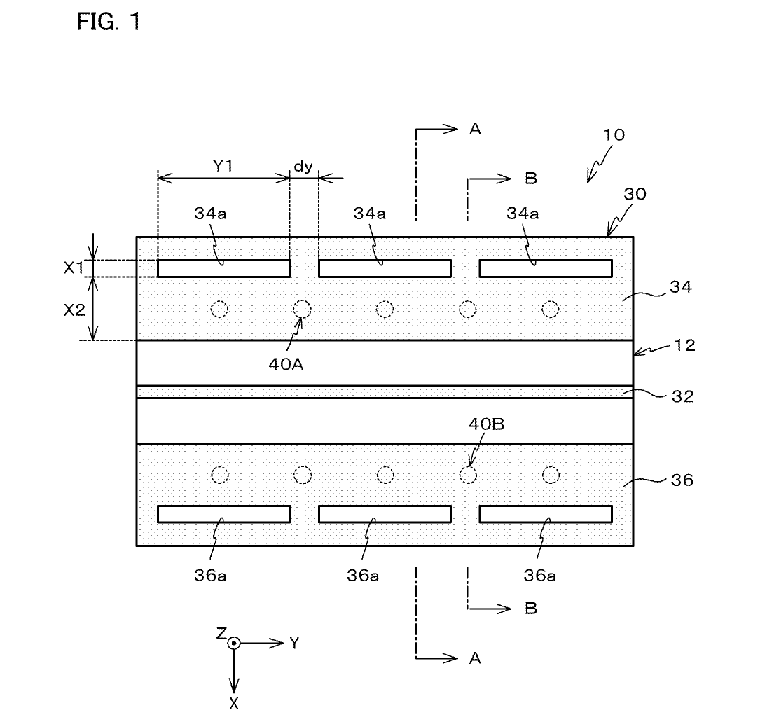

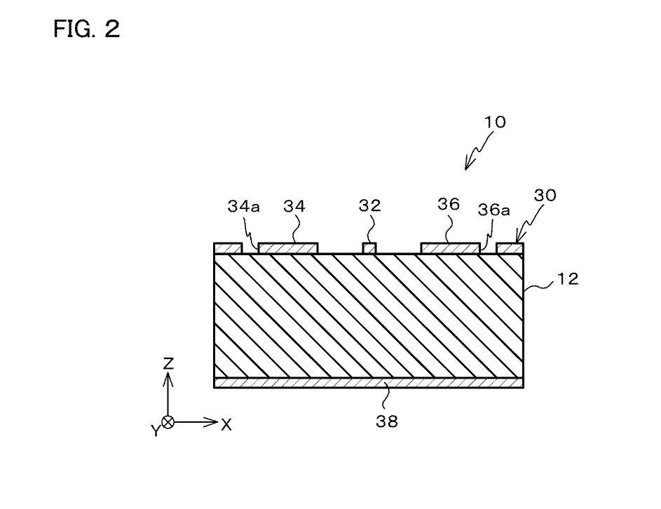

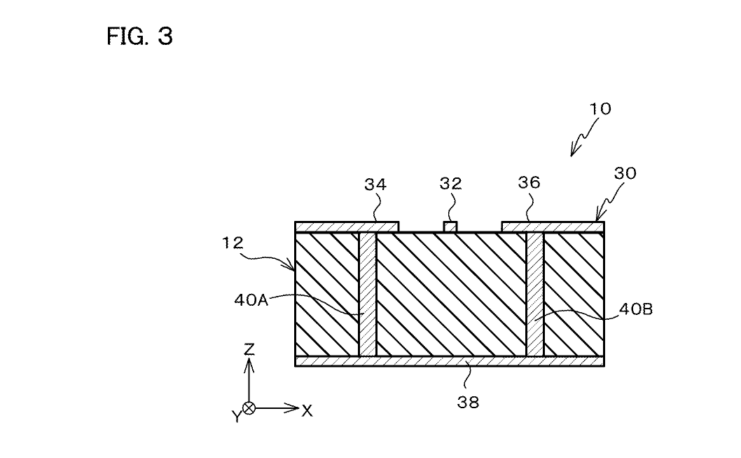

Below, the preferred embodiment of the present invention is described with reference to the drawings. FIG. 1 is a planar diagram of a wiring substrate 10 according to this preferred embodiment. FIG. 2 is a cross-sectional view of the wiring substrate 10 in FIG. 1 taken along line A-A. FIG. 3 is a cross-sectional view of the wiring substrate 10 in FIG. 1 taken along line B-B.

As can be seen by referring to FIGS. 1 to 3, the wiring substrate 10 is composed of a dielectric substrate 12 and a coplanar line 30 as a high-frequency transmission line formed on the top surface of the dielectric substrate 12.

As shown in FIGS. 1 to 3, the dielectric substrate 12 is a parallelepiped with the y-axis direction as the lengthwise direction. This dielectric substrate 12 has as a dielectric material alumina with a dielectric constant of 9.0. In addition, a ground pattern 38 is formed on the lower surface (the surface in the −z direction) of the dielectric substrate 12. This ground pattern 38 is composed of copper or copper foil, for example, and covers the entire lower surface of the dielectric substrate 12. For the dielectric substrate 12, it is possible to use a dielectric other than alumina, for example epoxy resin, polyimide resin, BT resin, PPE resin, Teflon (registered trademark), LTCC, and/or the like.

The coplanar line 30 is composed of a signal line conductor 32 formed on the top surface (surface on the +z side) of the dielectric substrate 12, and a first conductor pattern 34 and a second conductor pattern 36 formed on the top surface of the dielectric substrate 12 and on both sides of the signal line conductor 32.

The signal line conductor 32 is a conductor formed from the −y side edge to the +y side edge of the dielectric substrate 12. This signal line conductor 32 is composed of copper plating or copper foil, for example, and is formed so as to be parallel with the y-axis and pass through the center of the top surface of the dielectric substrate 12.

The first conductor pattern 34 is a conductor formed along the periphery of the −x side of the dielectric constant on the dielectric substrate 12 more to the −x side than the signal line conductor 32. The first conductor pattern 34 is composed of copper plating or copper foil, for example, and is formed in a parallelepiped shape with the y-axis direction being the lengthwise direction. In addition, formed in the first conductor pattern 34 are three rectangular slits 34a extending along the signal line conductor 32, the y-axis direction being the lengthwise direction, and positioned with substantially equal spacing (see FIG. 1).

The second conductor pattern 36 is a conductor formed along the periphery of the +x side of the dielectric constant on the dielectric substrate 12 more to the +x side than the signal line conductor 32. The second conductor pattern 36 is composed of copper plating or copper foil, for example, and is formed in a parallelepiped shape with the y-axis direction being the lengthwise direction. In addition, similar to the first conductor pattern 34, formed in the second conductor pattern 36 are three rectangular slits 36a extending along the signal line conductor 32, the y-axis direction being the lengthwise direction, and positioned with substantially equal spacing (see FIG. 1).

Here, the same number of slits 34a and slits 36a are formed, with the signal line conductor 32 as the boundary, but the number of slits 36a and slits 36b need not be the same.

Referring to FIG. 3, the first conductor pattern 34 is connected to the ground pattern 38 by multiple via conductors 40A formed on the dielectric substrate 12. In addition, the second conductor pattern 36 is connected to the ground pattern 38 by multiple via conductors 40B formed on the dielectric substrate 12.

The via conductors 40A that connect the first conductor pattern 34 and the ground pattern 38 are positioned in the +x side of the slits 34a along the y-axis with substantially equal spacing. In addition, the via conductors 40B that connect the second conductor pattern 36 and the ground pattern 38 are positioned in the −x side of the slits 36a along the y-axis with substantially equal spacing.

As shown in FIG. 1, when X1 (a.u.) is the width in the x-axis direction of the slits 34a formed in the first conductor pattern 34, Y1 (a.u.) is the width in the y-axis direction, X2 (a.u.) is the shortest distance from the +x side edge of the first conductor pattern to the slits 34a, and λ (a.u.) is the effective wavelength of the electromagnetic waves radiated from the signal line conductor (32), the following equation (1) is satisfied by the wiring substrate 10.

(X1+X2+Y1)×2=λ (1)

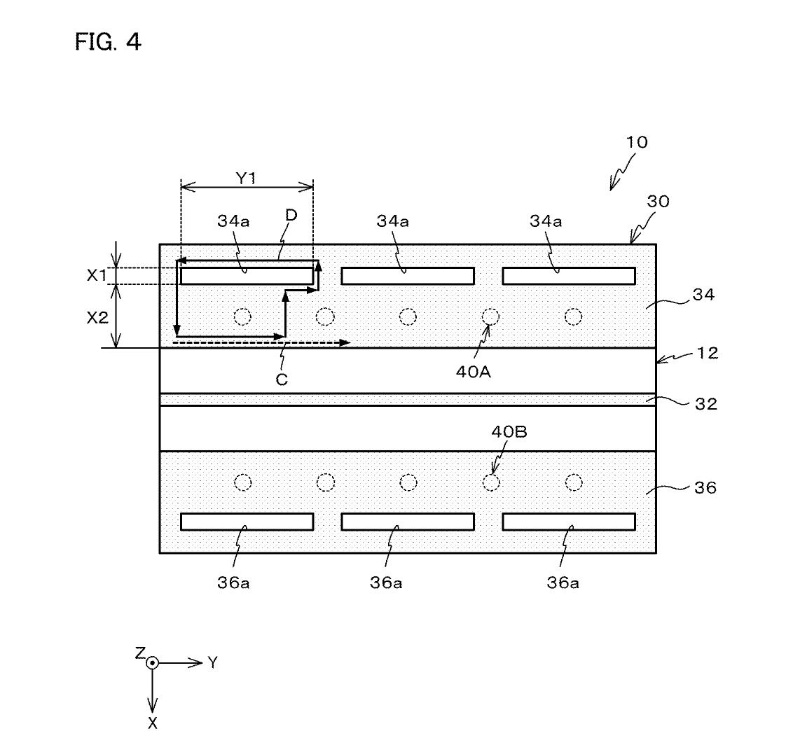

Below, the significance of equation (1) is explained with reference to FIG. 4. FIG. 4 is a drawing schematically showing the path of high-frequency electric current originating in high-frequency signals transmitted by the signal line conductor 32. A path D indicated by solid lines is the path of the first high-frequency electric current, and this first high-frequency electric current originates in electromagnetic waves radiated from the signal line conductor 32 and passing between the via conductors 40A positioned with equal spacing to the first conductor pattern 34. In addition, a path C indicated by a broken line is the path of high-frequency electric current originating in electromagnetic waves transmitted along the signal line conductor 32.

As can be understood by referring to FIG. 4, the first high-frequency electric current flows inside the first conductor pattern 34 through the path D along the periphery of the slits 34a and combines with the second high-frequency electric current flowing in path C.

So that the above-described equation (1) is satisfied, if the total distance of the path D (=(X1+X2+Y1)×2) is a value substantially equivalent to the effective wavelength λ of the electromagnetic waves immediately after being radiated to the first conductor pattern 34, the first high-frequency electric current flowing along this path D combines with the second high-frequency electric currently without having a large effect on the second high-frequency electric current flowing along the path C. The reason for this is that when the above-described equation (1) is established in this manner, the phase of the first high-frequency electric current and the phase of the second high-frequency electric current substantially match at the position where combining occurs. In this case, the electromagnetic waves radiated from the signal line conductor 34 are efficiently collected and radiation loss in the wiring substrate 10 is effectively controlled.

As explained above, with this preferred embodiment, slits 34a and 36a are respectively formed in the first conductor pattern 34 and the second conductor pattern 36 comprising the coplanar line 30. Furthermore, the total distance (=(X1+X2+Y1)×2) of the path D of the first high-frequency electric current and the effective wavelength λ of the electromagnetic waves immediately after being radiated to the first conductor pattern 34 have the relationship expressed by the above equation (1). Consequently, the first high-frequency electric current flowing along the path D combines with the second high-frequency electric current without having a significant effect on the second high-frequency electric current flowing along the path C. With this kind of coplanar line 30, the radiated electromagnetic waves are efficiently collected and radiation loss in the wiring substrate 10 is effectively controlled.

Radiation loss in the wiring substrate 10 is most effectively controlled when the total distance (=(X1+X2+Y1)×2) of the path D of the first high-frequency electric current and the effective wavelength λ of the electromagnetic waves immediately after being radiated to the first conductor pattern 34 satisfy the above-described equation (1). On the other hand, by combining the first high-frequency electric current and the second high-frequency electric current, the second high-frequency electric current receives the greatest effect when the difference between the phase of the first high-frequency electric current and the phase of the second high-frequency electric current at the position of combining (hereafter called simply the phase difference) is 180 degrees.

Accordingly, when the total distance of the path D is such that the phase difference between the first high-frequency electric current and the second high-frequency electric current is not 180 degrees, the second high-frequency electric current does not receive a significant effect from combining. Specifically, when the total distance (=(X1+X2+Y1)×2) of the path D and the effective wavelength λ of the electromagnetic waves immediately after being radiated to the first conductor pattern 34 satisfy the inequality shown in formula (2) below, the second high-frequency electric current does not receive significant effects from combining so radiation loss in the wiring substrate 10 can be controlled.

λ/2<(X1+X2+Y1)×2<3×λ/2 (2)

Consequently, even if the total distance (=(X1+X2+Y1)×2) of the path D in the wiring substrate 10 and the effective wavelength λ of the electromagnetic waves immediately after being radiated to the first conductor pattern 34 are not necessarily in the relationship expressed by the above-described equation (1) but are in the relationship expressed by the above-described formula (2), the radiated electromagnetic waves can be efficiently collected to a certain degree, and radiation loss in the wiring substrate 10 can be controlled.

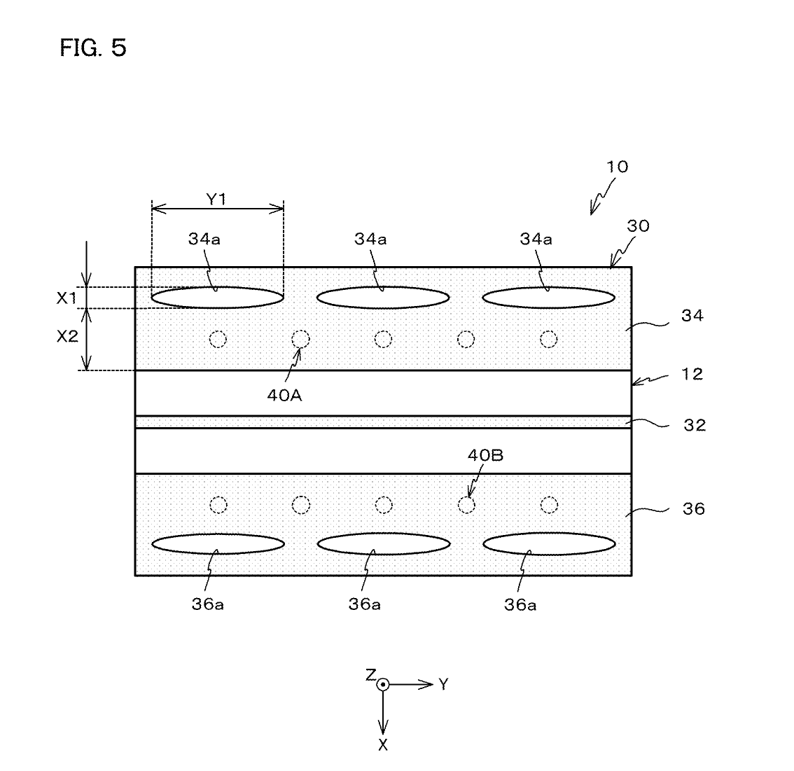

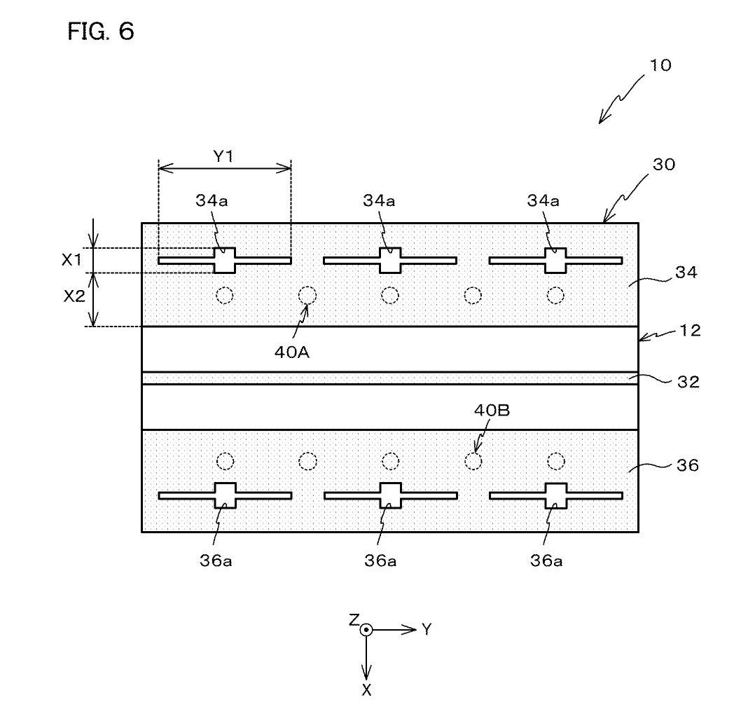

In addition, with the above-described preferred embodiment, the case where rectangular slits 34a and 36a with the y-axis direction as the lengthwise direction are formed in the first conductor pattern 34 and the second conductor pattern 36 was explained. These rectangular slits 34a and 36a are intended to be illustrative and not limiting, for it would be fine to have elliptical slits 34a and 36a whose major axis is parallel to the y-axis, for example as shown in FIG. 5. In addition, in place of the rectangular slits 34a and 36a, it would be fine to form polygonal slits 34a and 36a in the first conductor pattern 34 and the second conductor pattern 36, for example as shown in FIG. 6.

In this case, when X1 is the width of the slits 34a and 36a in the x-axis direction, Y1 is the width in the y-axis direction, and X2 is the shortest distance from the +x side edge of the first conductor pattern 34 to the slits 34a and the shortest distance from the −x side edge of the second conductor pattern 36 to the slits 36a, if the widths X1 and Y1 and the shortest distance X2 satisfy the above-described equation (1) or formula (2), a coplanar line 30 that can efficiently recover radiated electromagnetic waves is composed, and it is possible to control radiation loss in the wiring substrate 10.

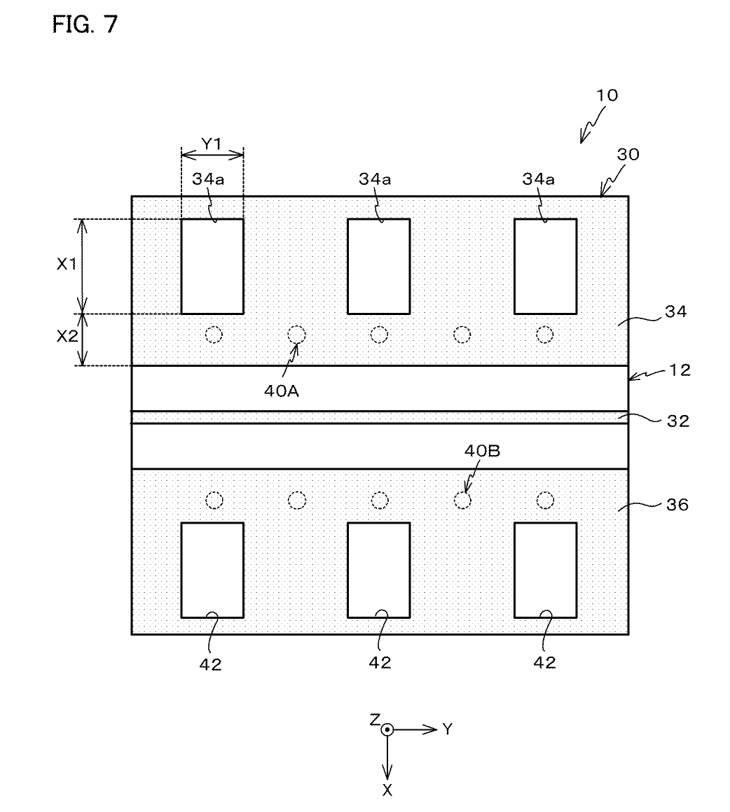

In addition, with the above-described preferred embodiment, the case where rectangular slits 34a and 36a with the y-axis direction as the lengthwise direction are formed in the first conductor pattern 34 and the second conductor pattern 36 was explained. This is intended to be illustrative and not limiting, for in place of the rectangular slits 34a and 36a, it would be fine to form rectangular slits 34a and 36a with the x-axis direction as the lengthwise direction in the first conductor pattern 34 and the second conductor pattern 36, for example as shown in FIG. 7.

In addition, with the above-described preferred embodiment, the case where three slits 34a and 36a were formed in the first conductor pattern 34 and the second conductor pattern 36, respectively, was explained. This is intended to be illustrative and not limiting, for it would be fine for four or more slits 34a and 36a satisfying the above-described equation (1) or the above-described formula (2) to be formed, or for one or two slits 34a and 36a to be formed, in the first conductor pattern 34 and the second conductor pattern 36, respectively. In addition, the number of slits 34a and 36a in the first conductor pattern 34 and the second conductor pattern, respectively, need not be the same number.

In addition, with the above-described preferred embodiment the case where the slits 34a and 36a are formed with substantially equal spacing along the x-axis was explained. This is intended to be illustrative and not limiting, for the slits 34a and 36a may be formed so that the spacing between adjacent slits 34a and 36a are mutually different.

In addition, with the above-described preferred embodiment the case where slits 34a and 36a of the same shape are formed in the first conductor pattern 34 and the second conductor pattern 36, respectively, was explained. This is intended to be illustrative and not limiting, for slits 34a and 36a of mutually differing shapes may be formed in the first conductor pattern 34 and the second conductor pattern 36, respectively.

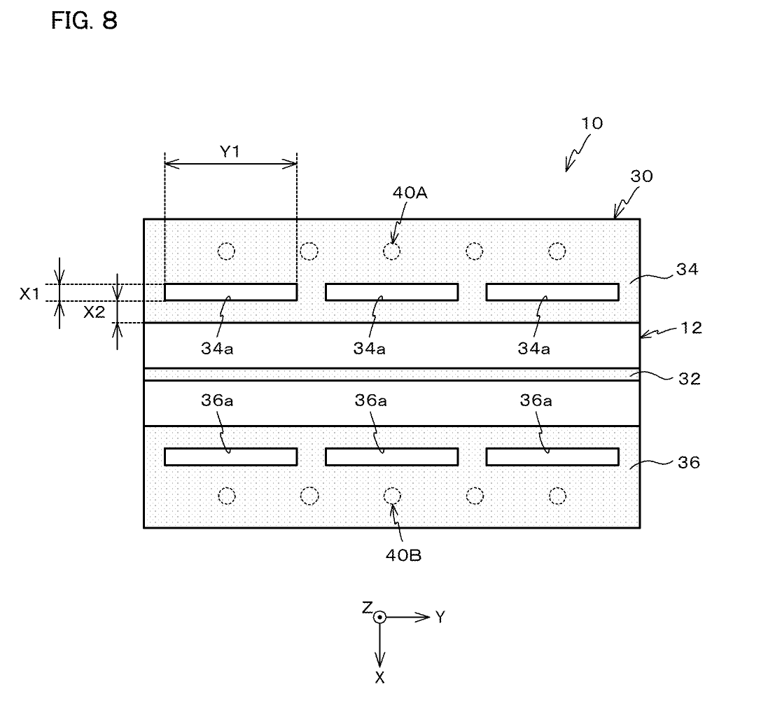

In addition, with the above-described preferred embodiment, the via conductors 40A are formed with equal spacing along the y-axis on the +x side of the slits 34a (the side adjacent to the signal line conductor 32), as shown in FIG. 1. Furthermore, the via conductors 40B are formed with equal spacing along the y-axis on the −x side of the slits 36a (the side separated from the signal line conductor 32). This is intended to be illustrative and not limiting, for the via conductors 40A may be formed with equal spacing along the y-axis on the −x side of the slits 34a (the side separated from the signal line conductor 32), for example as shown in FIG. 8. In addition, the via conductors 40B may be formed with equal spacing along the y-axis on the +x side of the slits 36a (the side adjacent to the signal line conductor 32), for example as shown in FIG. 8.

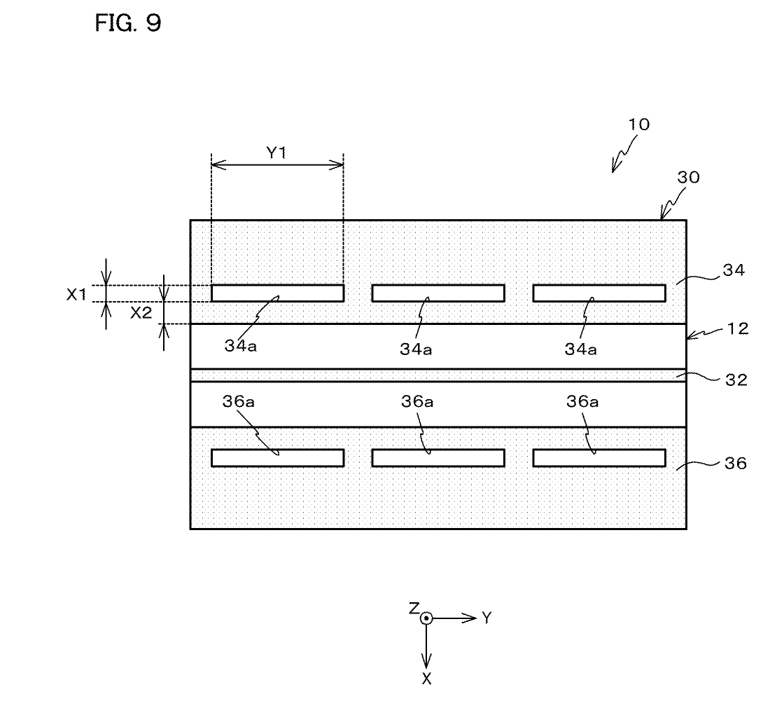

In addition, with the above-described preferred embodiment, the first conductor pattern 34 is connected to the ground pattern 38 by the via conductors 40A, as shown in FIG. 3. In addition, the second conductor pattern 36 is connected to the ground pattern 38 by the via conductors 40B. This is intended to be illustrative and not limiting, for the first conductor pattern 34 and the second conductor pattern 36 may be electrically connected by conductors other than via conductors, such as through-hole conductors. In addition, the first conductor pattern 34 and the ground pattern 38, and the second conductor pattern 36 and the ground pattern 38, need not necessarily be electrically connected, for example as shown in FIG. 9.

Furthermore, multiple build-up layers may be formed on the top surface or the bottom surface of the wiring substrate 10, and the ground pattern 38 may be formed inside the dielectric substrate 12.

The wiring substrate 10 according to the above-described preferred embodiment can be used as the substrate of a high-frequency module incorporated in electronic devices, for example mobile phones, PDAs (Personal Digital Assistants), PHS (Personal Handy-phone System), mobile PCs (Mobile Personal Computers) and/or the like.

Next, a practical example of the present invention will be described.

With reference to FIG. 1, the dielectric substrate 12 in the wiring substrate 10A according to this practical example is an alumina substrate with a thickness of 250 μm and a dielectric constant of 9.0 (F/m). Furthermore, formed on the top surface of the dielectric substrate 12 is a signal line conductor 32 with a dimension (width) in the x-axis direction of 100 μm and a line length of 2,400 μm.

The first conductor pattern 34 and the second conductor pattern 36 have a thickness of 10 μm. In addition, the dimension in the x-axis direction is 2,400 μm, and the dimension in the y-axis direction is 400 μm.

The distance between the −x side edge (periphery) of the signal line conductor 32 and the +x side edge (periphery) of the first conductor pattern 34 is 250 μm. Similarly, the distance between the +x side edge (periphery) of the signal line conductor 32 and the −x side edge (periphery) of the second conductor pattern 36 is 250 μm.

The slits 34a and 36a have a dimension X1 in the x-axis direction of 100 μm and a dimension Y1 in the y-axis direction of 700 μm. In addition, the distance dy between adjacent slits 34a is 100 μm. Furthermore, the slits 34a are positioned at a position whose distance X2 from the +x side edge (periphery) of the first conductor pattern 34 is 200 μm, and the slits 36a are positioned at a position whose distance X2 from the −x side edge (periphery) of the second conductor pattern 36 is 200 μm.

The via conductors 40A and 40B all have diameters of 100 μm. In addition, the position spacing in the y-axis direction is 400 μm. Furthermore, the via conductors 40A are positioned at positions separated by 300 μm in the +x direction from the −x side edge of the first conductor pattern 34, and the via conductors 40B are positioned at positions separated by 300 μm in the −x direction from the +x side edge (periphery) of the second conductor pattern 36.

With reference to FIG. 2, the ground pattern 38 has a thickness of 10 μm. In addition, the dimension in the x-axis direction is 2,400 μm and the dimension in the y-axis direction is 1,400 μm.

In addition, a substrate the same as the dielectric substrate 12 shown in FIG. 1 is positioned on the top surface of the wiring substrate 10A according to this practical example.

On the other hand, a wiring substrate 10B according to a comparison example is prepared which has the same composition as the wiring substrate 10A of the above-described practical example except that slits are not formed in the first conductor pattern 34 and second conductor pattern 36.

However, the wavelength λ of the electromagnetic waves is found from the following equation (3) when c (m/s) is the speed of light, f (Hz) is the frequency and a (non-dimensional quantity) is the dielectric constant of the medium.

λ=c/f/√∈r (3).

Here, because the total distance (=X1+X2+Y1)×2) of the path D is 2,000 μm, 2,000 μm is substituted into equation (3) as the value of the wavelength λ. In addition, the dielectric substrate 12 has a dielectric constant of 9.0, so 9.0 is substituted into equation (3) as the value of the dielectric constant ∈r. In addition, because the speed of light is 3×10⁸ m/s (≈299,792,458 m/s), 3×10⁸ m/s is substituted into equation (3) as the value of the speed of light c. Accordingly, from equation (3) the value of the frequency f is found to be 50 GHz. This result means that with the wiring substrate 10A (coplanar line 30) according to this practical example, the radiation loss of a high-frequency signal whose frequency is 50 GHz is most effectively controlled.

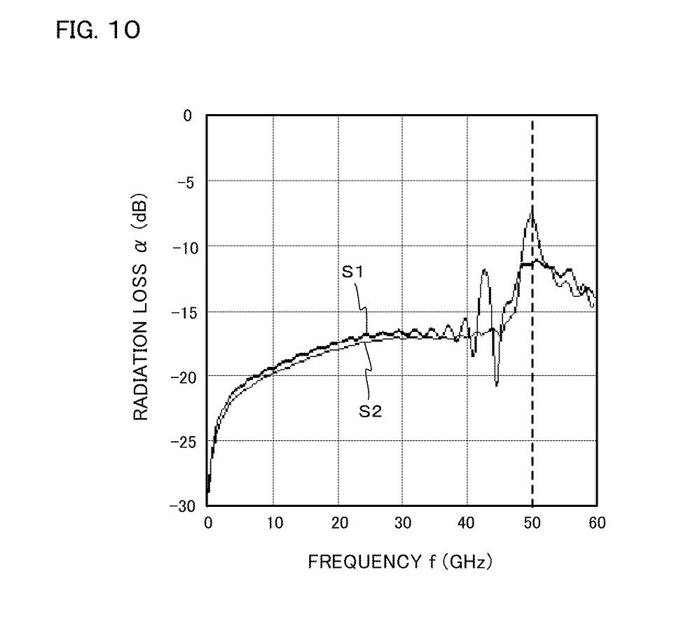

FIG. 10 is a drawing showing the relationship between the radiation loss α and the frequency f. A curve S1 is a curve showing the radiation loss properties in the wiring substrate 10A according to this practical example. In addition, a curve S2 is a curve showing the radiation loss properties in the wiring substrate 10B according to the comparison example. Here, the radiation loss α (dB) is expressed by the following equation (4) using a reflection property S11 and transmission property S21 measured by a network analyzer.

α=1−|S11|²−|S21|² (4)

As shown in FIG. 10, with the wiring substrate 10B according to the comparison example, the radiation loss at a frequency of 50 GHz is around −7.5 dB. On the other hand, with the wiring substrate 10A according to this practical example, the radiation loss at a frequency of 50 GHz is around −11.0 dB. Accordingly, by forming the slits 34a and 36a in the first conductor pattern 34 and the second conductor pattern 36, respectively, it can be seen that the radiation loss at a frequency of 50 GHz is improved by around 3.5 dB.

Having described and illustrated the principles of this application by reference to one preferred embodiment, it should be apparent that the preferred embodiment may be modified in arrangement and detail without departing from the principles disclosed herein and that it is intended that the application be construed as including all such modifications and variations insofar as they come within the spirit and scope of the subject matter disclosed herein.

All or portions of the above-described preferred embodiment may also be noted in the Supplementary notes below but are not limited thereby.

(Supplementary Note 1)

A high-frequency transmission line, comprising:

a signal line conductor formed on a surface of a dielectric; and

a conductor pattern formed on the dielectric so as to extend along the signal line conductor;

wherein a slit extending along the signal line conductor is formed in the conductor pattern.

(Supplementary Note 2)

The high-frequency transmission line of Supplementary note 1, wherein the conductor pattern is formed on the dielectric and on both sides of the signal line conductor.

(Supplementary Note 3)

The high-frequency transmission line of Supplementary note 1, wherein multiple slits are formed along the signal line conductor.

(Supplementary Note 4)

The high-frequency transmission line of Supplementary note 2, wherein multiple slits are respectively formed on both sides of the signal line conductor in the conductor pattern.

(Supplementary Note 5)

The high-frequency transmission line of Supplementary note 3 or Supplementary note 4, wherein the multiple slits all have identical shapes.

(Supplementary Note 6)

The high-frequency transmission line of Supplementary note 3 or Supplementary note 4, wherein the multiple slits all have mutually differing shapes.

(Supplementary Note 7)

The high-frequency transmission line of any of Supplementary notes 3 through 6, wherein the multiple slits are positioned with substantially equal spacing.

(Supplementary Note 8)

The high-frequency transmission line of any of Supplementary notes 3 through 6, wherein among the multiple slits, the spacing between adjacent slits mutually differs.

(Supplementary Note 9)

The high-frequency transmission line of any of Supplementary notes 1 through 8, wherein when X1 is the width of the slits in a direction orthogonal to the signal line conductor, Y1 is the width of the slits in a direction parallel to the signal line conductor, X2 is the shortest distance from the edge of the signal line conductor side of the conductor pattern to the slits and λ is the wavelength of electromagnetic waves radiated from the first signal line conductor, the inequality expressed by λ/2<(X1+X2+Y1)×2<3×λ/2 is satisfied.

(Supplementary Note 10)

The high-frequency transmission line of Supplementary note 9, wherein the equation expressed by (X1+X2+Y1)×2=λ is satisfied.

(Supplementary Note 11)

A circuit substrate comprising:

a substrate;

the high-frequency transmission line of any of Supplementary notes 1 through 10 formed on a surface on one side of this substrate; and

a conductor pattern formed on a surface of the other side of this substrate.

This application claims the benefit of Japanese Patent Application 2010-049038, filed 5 Mar. 2010, the entire disclosure of which is incorporated by reference herein.

### INDUSTRIAL APPLICABILITY

The present invention can be applied to a high-frequency transmission line for transmitting high-frequency signals, and a circuit substrate on which this high-frequency transmission line is formed.

### DESCRIPTION OF REFERENCE NUMERALS

10 Wiring substrate
12 Dielectric substrate
30 Coplanar line
32 Signal line conductor
34 First conductor pattern
34a Slits
36 Second conductor pattern
36a Slits
38 Ground pattern
40A, 40B Via conductors
C, D Paths

1. A high-frequency transmission line, comprising:
a signal line conductor formed on a surface of a dielectric; and
a conductor pattern formed on the dielectric so as to extend along the signal line conductor;
wherein a slit extending along the signal line conductor is formed in the conductor pattern.

2. The high-frequency transmission line according to claim 1, wherein the conductor pattern is formed on the dielectric and on both sides of the signal line conductor.

3. The high-frequency transmission line according to claim 1, wherein multiple slits are formed along the signal line conductor.

4. The high-frequency transmission line according to claim 2, wherein multiple slits are respectively formed on both sides of the signal line conductor in the conductor pattern.

5. The high-frequency transmission line according to claim 3, wherein the multiple slits all have identical shapes.

6. The high-frequency transmission line according to claim 3, wherein the multiple slits all have mutually differing shapes.

7. The high-frequency transmission line according to claim 3, wherein the multiple slits are positioned with substantially equal spacing.

8. The high-frequency transmission line, according to claim 3 wherein among the multiple slits, the spacing between adjacent slits mutually differs.

9. The high-frequency transmission line according to claim 1, wherein when X1 is the width of the slits in a direction orthogonal to the signal line conductor, Y1 is the width of the slits in a direction parallel to the signal line conductor, X2 is the shortest distance from the edge of the signal line conductor side of the conductor pattern to the slits and λ is the wavelength of electromagnetic waves radiated from the first signal line conductor, the inequality expressed by λ/2<(X1+X2+Y1)×2<3×λ/2 is satisfied.

10. The high-frequency transmission line according to claim 9, wherein the equation expressed by (X1+X2+Y1)×2=λ is satisfied.

11. A circuit substrate comprising:
a substrate;
the high-frequency transmission line according to claim 1 formed on a surface on one side of said substrate; and
a conductor pattern formed on a surface of the other side of said substrate.

12. The high-frequency transmission line according to claim 4, wherein the multiple slits all have identical shapes.

13. The high-frequency transmission line according to claim 4, wherein the multiple slits all have mutually differing shapes.

14. The high-frequency transmission line according to claim 4, wherein the multiple slits are positioned with substantially equal spacing.

15. The high-frequency transmission line according to claim 5, wherein the multiple slits are positioned with substantially equal spacing.

16. The high-frequency transmission line according to claim 6, wherein the multiple slits are positioned with substantially equal spacing.

17. The high-frequency transmission line, according to claim 4 wherein among the multiple slits, the spacing between adjacent slits mutually differs.

18. The high-frequency transmission line, according to claim 5 wherein among the multiple slits, the spacing between adjacent slits mutually differs.

19. The high-frequency transmission line, according to claim 6 wherein among the multiple slits, the spacing between adjacent slits mutually differs.

20. The high-frequency transmission line according to claim 2, wherein when X1 is the width of the slits in a direction orthogonal to the signal line conductor, Y1 is the width of the slits in a direction parallel to the signal line conductor, X2 is the shortest distance from the edge of the signal line conductor side of the conductor pattern to the slits and λ is the wavelength of electromagnetic waves radiated from the first signal line conductor, the inequality expressed by λ/2<(X1+X2+Y1)×2<3×λ/2 is satisfied.
